(19) United States
(12) Patent Application Publication
(10) Pub. No.: US 2022/0143833 A1
(43) Pub. Date: May 12, 2022

(54) COMPUTER-READABLE RECORDING MEDIUM STORING ABNORMALITY DETERMINATION PROGRAM, ABNORMALITY DETERMINATION METHOD, AND ABNORMALITY DETERMINATION APPARATUS

(71) Applicant: FUJITSU LIMITED, Kawasaki-shi (JP)

(72) Inventors: Yasuto Yokota, Kawasaki (JP); Kanata Suzuki, Kawasaki (JP)

(73) Assignee: FUJITSU LIMITED, Kawasaki-shi (JP)

(21) Appl. No.: 17/408,077

(22) Filed: Aug. 20, 2021

(30) Foreign Application Priority Data
Nov. 11, 2020 (JP) 2020-187980

(51) Int. Cl. B25J 9/16; G06K 9/46; G06K 9/62; G06T 1/00; G06N 3/04

(52) U.S. Cl. CPC B25J 9/1674; G06K 9/46; G06K 9/6202; G06K 9/629; B25J 9/163; G06N 3/0445; G06K 9/6217; G06T 1/0014

(57) ABSTRACT

A non-transitory computer-readable recording medium stores an abnormality determination program for causing a computer to execute a process for determining an abnormality including: generating, based on first motion information of a device generated for a first timing by a machine learning model and a plurality of first feature quantities obtained by sensing the device at the first timing, estimated values of second motion information and a plurality of second feature quantities for a second timing that is after the first timing by using the machine learning model; controlling, based on the second motion information, a motion of the device at the second timing; comparing a plurality of second feature quantities obtained by sensing the device at the second timing with the generated estimated values of the plurality of second feature quantities; and determining, based on a result of the comparing, whether there is an abnormality.

### CROSS-REFERENCE TO RELATED APPLICATION

This application is based upon and claims the benefit of priority of the prior Japanese Patent Application No. 2020-187980, filed on Nov. 11, 2020, the entire contents of which are incorporated herein by reference.

### FIELD

The embodiments discussed herein are related to an abnormality determination technique.

### BACKGROUND

In recent years, in control of industrial machines and robot arms, the introduction of a recurrent-type neural network such as a recurrent neural network (RNN) or a long short-term memory (LSTM) is underway in order to reduce teaching work.

K. Suzuki, H. Mori, and T. Ogata, “Undefined-behavior guarantee by switching to model-based controller according to the embedded dynamics in Recurrent Neural Network”, arXiv:2003.04862v1, https://arxiv.org/abs/2003.04862v1 is disclosed as related art.

### SUMMARY

According to an aspect of the embodiments, a non-transitory computer-readable recording medium stores an abnormality determination program for causing a computer to execute a process for determining an abnormality including: generating, based on first motion information of a device generated for a first timing by a machine learning model and a plurality of first feature quantities obtained by sensing the device at the first timing, estimated values of second motion information and a plurality of second feature quantities for a second timing that is after the first timing by using the machine learning model; controlling, based on the second motion information, a motion of the device at the second timing; comparing a plurality of second feature quantities obtained by sensing the device at the second timing with the generated estimated values of the plurality of second feature quantities; and determining, based on a result of the comparing, whether there is an abnormality.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram for describing an overview of embodiments;

FIG. 2 is an explanatory diagram for describing an example of a robot arm;

FIG. 3 is a block diagram illustrating an example of a functional configuration of an abnormality determination apparatus according to a first embodiment;

FIG. 4 is a flowchart illustrating an example of preliminary work of the abnormality determination apparatus according to the first embodiment;

FIG. 5 is a flowchart illustrating an example of an operation of the abnormality determination apparatus according to the first embodiment;

FIG. 6 is a block diagram illustrating an example of a functional configuration of an abnormality determination apparatus according to a second embodiment;

FIG. 7 is an explanatory diagram for describing visualization of an abnormal location; and

FIG. 8 is an explanatory diagram for describing an example of a configuration of a computer.

### DESCRIPTION OF EMBODIMENTS

In device control using this recurrent-type neural network, there is known a related-art technique for detecting an abnormal state of a device, based on an error between an estimated value of pose information of the device predicted by the recurrent-type neural network and a history of actual pose information.

With the related-art technique described above, the occurrence of an abnormality in the pose of a device is successfully detected but it is difficult to identify whether there is an abnormality in sensing of the device, which is problematic.

In one aspect, a computer-readable recording medium storing an abnormality determination program, an abnormality determination method, and an abnormality determination apparatus that are capable of identifying whether there is an abnormality in sensing of a device may be provided.

An abnormality determination program, an abnormality determination method, and an abnormality determination apparatus according to embodiments will be described below with reference to the drawings. In the embodiments, components having the same function are denoted by the same reference sign, and redundant description is omitted. The abnormality determination program, the abnormality determination method, and the abnormality determination apparatus described in the embodiments below are merely an example and do not limit the embodiments. The individual embodiments below may be appropriately combined with each other within a scope without any contradiction.

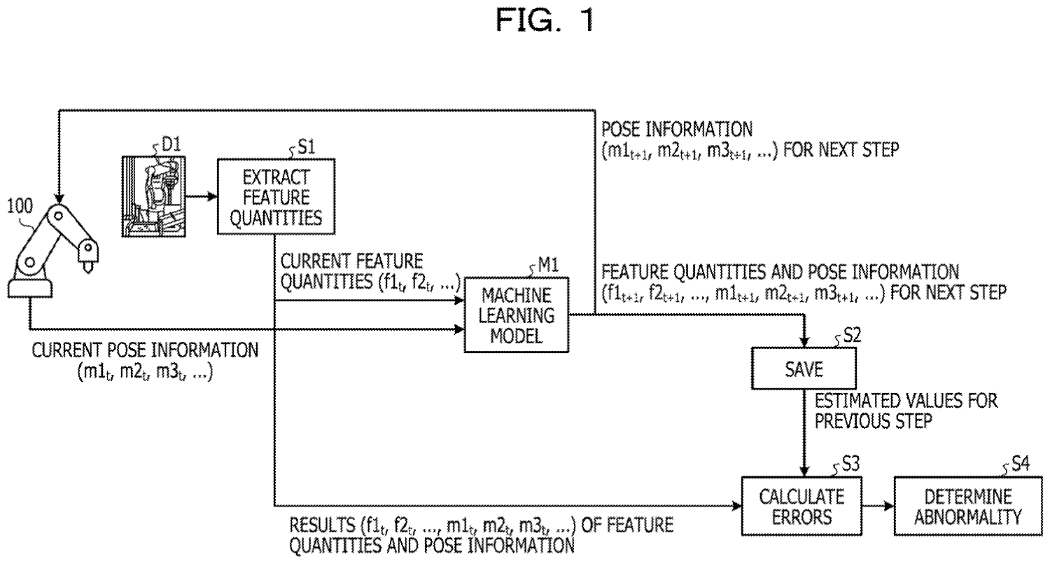

FIG. 1 is an explanatory diagram for describing an overview of embodiments. As illustrated in FIG. 1, the present embodiments are to determine whether there is an abnormality when a robot arm 100, which is an example of a device, is controlled by using a machine learning model M1, which is a recurrent-type neural network such as an RNN or an LSTM. The device to be controlled is not limited to the robot arm 100. For example, a position of a control axis, a feed speed of a workpiece, a machining speed, and the like in an automatic lathe may be controlled by using the machine learning model M1.

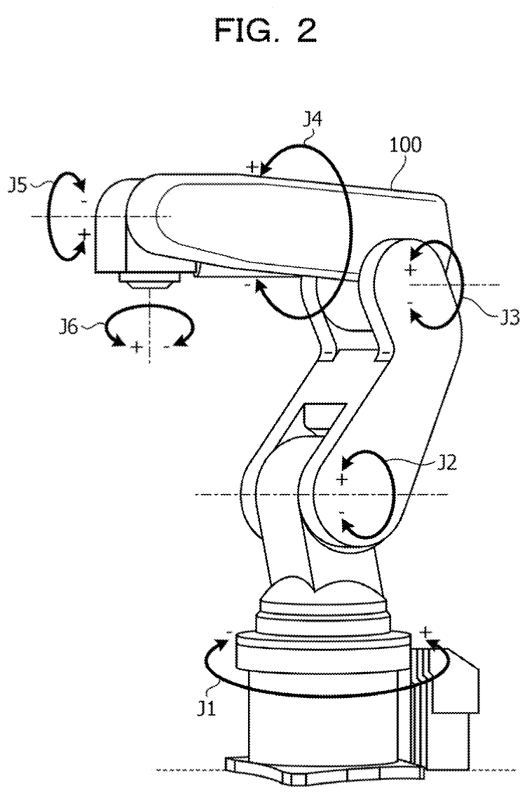

FIG. 2 is an explanatory diagram for describing an example of the robot arm 100. As illustrated in FIG. 2, the robot arm 100 is an industrial robot arm having degrees of freedom with respect to axes J1 to J6. The pose of the robot arm 100 thus having a high degree of freedom is not uniquely determined by space coordinates of an arm tip position. Accordingly, a trajectory of the arm for each motion is determined in advance, and the machine learning model M1 that predicts pose information (m1 corresponding to the axis J1, m2 corresponding to the axis J2, . . . ) representing the pose of the robot arm 100 (changes in angles with respect to the respective axes J1 to J6) as motion information for implementing the motion state is created through machine learning.

As illustrated in FIG. 1, in the present embodiments, when the motion of the robot arm 100 is controlled, an autoencoder (AE) or the like extracts a feature quantity from sensing data obtained by sensing the robot arm 100 (S1). For example, in the present embodiments, when the current time is denoted by t, the autoencoder extracts a feature quantity (f1ₜ) from an image D1 obtained by imaging (sensing) an appearance of the robot arm 100 and its surroundings at the time t. In the case where an autoencoder is used, a value (latent variable) obtained from an intermediate layer when the image D1 is input to the autoencoder is used as a feature quantity (f1) (the subscript t is omitted in the case where the time is an arbitrary time). The feature quantity f1ₜ is one of a plurality of feature quantities obtained by sensing the robot arm 100 at the (current) time t.

The feature quantity f1ₜ is not limited to a feature quantity extracted from the image D1 obtained by imaging the robot arm 100. For example, the feature quantity f1ₜ may be extracted from an image captured by a camera installed at the robot arm 100, for example, an image captured from a viewpoint of the robot arm 100. It is assumed that there are a plurality of feature quantities fₜ such as pieces of sensor data of various sensors such as a position sensor and an acceleration sensor installed at the robot arm 100 or pieces of data (for example, f2ₜ) extracted from these pieces of sensor data by using the AE or the like.

In the present embodiments, the feature quantities (f1ₜ, f2ₜ, . . . ) obtained by sensing the robot arm 100 at the (current) time t and pose information (m1ₜ, m2ₜ, m3ₜ, . . . ) of the robot arm 100 are input to the machine learning model M1. The machine learning model M1 uses, by regression, estimated values of the feature quantities and the pose information which are most recently predicted by the machine learning model M1, and, based on the input current feature quantities (f1ₜ, f2ᵣ, . . . ) and pose information (m1ₜ, m2ₜ, m3ₜ, . . . ), predicts feature quantities (f1ₜ₊₁, f2ₜ₊₁, . . . ) and pose information (m1ₜ₊₁, m2ₜ₊₁, m3ₜ₊₁, . . . ) for the next step.

In the present embodiments, the predicted pose information (m1ₜ₊₁, m2ₜ₊₁, m3ₜ₊₁, . . . ) for the next step is transmitted to the robot arm 100. Thus, in the present embodiments, for example, the robot arm 100 is caused to move to the position indicated by the transmitted pose information.

The feature quantities (f1ₜ₊₁, f2ₜ₊₁, . . . ) and the pose information (m1ₜ₊₁, m2ₜ₊₁, m3ₜ₊₁, . . . ) which are predicted for the next step by the machine learning model M1 are stored (saved) in a memory or the like (S2).

In the present embodiments, the already saved estimated values (the feature quantities (f1ₜ, f2ₜ, . . . ) and the pose information (m1ₜ, m2ₜ, m3ₜ, . . . )) for the previous step are read from the memory. In the present embodiments, an error is calculated by comparing each of results (f1ₜ, f2ₜ, . . . , m1ₜ, m2ₜ, m3ₜ, . . . ) of the feature quantities and the pose information at the time t with a corresponding one of the estimated values for the previous step (S3). For example, in the present embodiments, for individual output nodes (for f1, f2, . . . , m1, m2, m3, . . . ) of the machine learning model M1, the results and the estimated values of the feature quantities and the pose information are compared, so that errors for the individual output nodes are calculated.

In the present embodiments, based on the errors for the respective output nodes (for f1, f2, . . . , m1, m2, m3, . . . ) of the machine learning model M1, it is determined whether there is an abnormality for the respective output nodes (S4).

For example, in the present embodiments, a total (or an average) of the error for each of the output nodes over a plurality of steps is calculated as a degree of abnormality. In the present embodiments, if the calculated degree of abnormality exceeds a threshold set in advance, it is determined that an abnormality (or a sign of an abnormality) has occurred in an information source location (for example, the captured image, the acceleration sensor, or the pose with respect to each axis) of the output node. As described above, in the present embodiments, whether there is an abnormality (or a sign of an abnormality) in sensing of the robot arm 100 may be identified based on the degrees of abnormality corresponding to the output nodes (for f1, f2, . . . ) of the machine learning model M1.

### First Embodiment

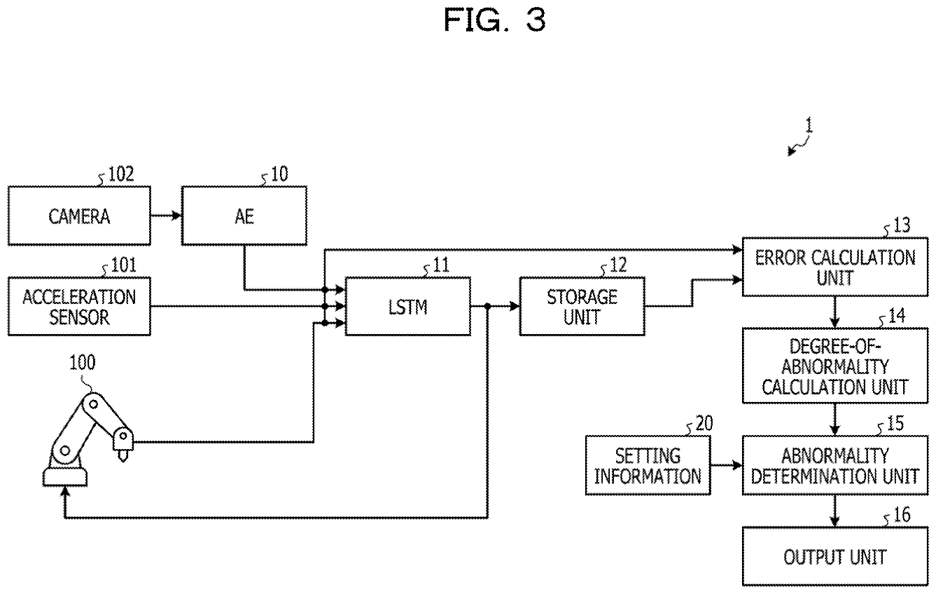

FIG. 3 is a block diagram illustrating an example of a functional configuration of an abnormality determination apparatus according to a first embodiment. As illustrated in FIG. 3, an abnormality determination apparatus 1 includes an AE 10, an LSTM 11, a storage unit 12, an error calculation unit 13, a degree-of-abnormality calculation unit 14, an abnormality determination unit 15, and an output unit 16.

The AE 10 extracts the feature quantity (f1) from the image D1 obtained by a camera 102 that images the robot arm 100. The feature quantity (f1) extracted by the AE 10 is input to the LSTM 11 together with sensor data (f2) obtained by an acceleration sensor 101.

The LSTM 11 is an example of a recurrent-type neural network corresponding to the machine learning model M1. The LSTM 11 accepts inputs of the feature quantity (f1) extracted by the AE 10, the sensor data (f2) obtained by the acceleration sensor 101, and the pose information (m1, m2, . . . ) with respect to the individual axes obtained from sensors (for example, encoders) installed for the axes J1 to J6 of the robot arm 100. The LSTM 11 uses, by regression, the estimated values of the feature quantities (f1, f2, . . . ) and the pose information (m1, m2, . . . ) which are most recently predicted by the LSTM 11, and, based on the input current feature quantities (f1, f2, . . . ) and pose information (m1, m2, . . . ), outputs estimated values of future feature quantities (f1, f2, . . . ) and pose information (m1, m2, . . . ).

The abnormality determination apparatus 1 transmits the pose information (m1, m2, . . . ) predicted by the LSTM 11 to the robot arm 100 as move-destination pose information. Thus, the abnormality determination apparatus 1 causes the robot arm 100 to move to the position indicated by the move-destination pose information.

The storage unit 12 is a memory or the like that stores the estimated values of the feature quantities (f1, f2, . . . ) and the pose information (m1, m2, . . . ) which are predicted by the LSTM 11.

The error calculation unit 13 is a processing unit that calculates, for each of the output nodes (for f1, f2, . . . , m1, m2, . . . ) of the LSTM 11, an error between the estimated value and the result value. For example, the error calculation unit 13 reads the estimated values (f1ₜ, f2ₜ, . . . , m1ₜ, m2ₜ, . . . ) for the previous step from the storage unit 12, and calculates errors by comparing the read estimated values with the results (f1ₜ, f2ₜ, . . . , m1ₜ, m2ₜ, . . . ) of the feature quantities and the pose information.

The degree-of-abnormality calculation unit 14 calculates a degree of abnormality by totalizing (or averaging) the error, calculated by the error calculation unit 13, between the estimated value and the result value for each of the output nodes (for f1, f2, . . . , m1, m2, . . . ) of the LSTM 11 over a plurality of steps. For example, the degree-of-abnormality calculation unit 14 calculates a mean square error by totalizing values, over a plurality of latest steps (for example, 100 steps), of the error for each of the output nodes (for f1, f2, . . . , m1, m2, . . . ) of the LSTM 11.

The abnormality determination unit 15 is a processing unit that determines whether there is an abnormality for each of the output nodes (for f1, f2, . . . , m1, m2, . . . ) of the LSTM 11, based on the degree of abnormality calculated by the degree-of-abnormality calculation unit 14 for a corresponding one of the output nodes. For example, the abnormality determination unit 15 compares the degree of abnormality for each of the output nodes (for f1, f2, . . . , m1, m2, . . . ) with a threshold that is included in setting information 20 set in advance and is for use in assessing the degree of abnormality, and determines that there is an abnormality (or a sign of an abnormality) for the output node for which the degree of abnormality exceeds the threshold. For example, the abnormality determination unit 15 may determine that there is a sign of an abnormality if the degree of abnormality exceeds a first threshold, and may determine that there is an abnormality if the degree of abnormality exceeds a second threshold that is greater than the first threshold.

The abnormality determination unit 15 refers to a correspondence relationship, included in the setting information 20, between the output nodes of the LSTM 11 and the feature quantities (for the image, the acceleration sensor, . . . ) and the pose information (for the axes J1, J2, . . . ), and identifies an abnormal location (the image, the acceleration sensor, . . . , and the axes J1, J2, . . . ) corresponding to the output node for which it is determined that there is an abnormality. The abnormality determination unit 15 notifies the output unit 16 of the abnormality determination result described above.

The output unit 16 is a processing unit that outputs the determination result obtained by the abnormality determination unit 15 as an indication on a display, output sound, or the like. For example, the output unit 16 displays, on a display or the like, the abnormal location corresponding to the output node for which the abnormality determination unit 15 has determined that there is an abnormality. This allows the user to easily identify the abnormal location.

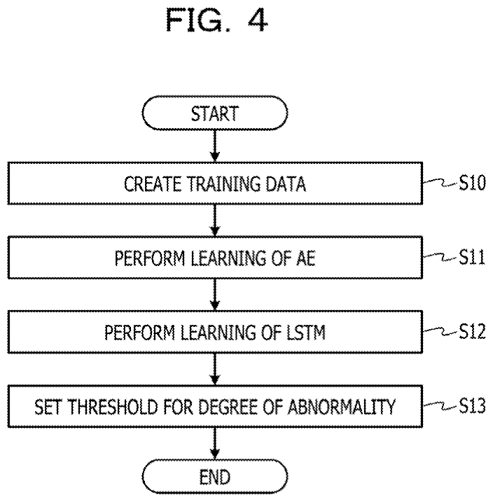

FIG. 4 is a flowchart illustrating an example of preliminary work of the abnormality determination apparatus 1 according to the first embodiment. As illustrated in FIG. 4, in the preliminary work, the robot arm 100 is manually operated in accordance with approximately a dozen or so example motion patterns which are desirably learned by the robot arm 100 as motions. The abnormality determination apparatus 1 creates training data by using, as a set, the image D1 obtained by the camera 102, the sensor data obtained by the acceleration sensor 101, and the pose information (m1, m2, . . . ) of the robot arm 100 during this operation (S10).

For example, a manual operation of a single motion pattern in which the robot arm 100 starts moving from a home position, then grasps a bolt on a table, then places the bolt in a box located nearby, and then returns to the home position is performed for 20 sets. Consequently, the abnormality determination apparatus 1 creates training data for 20 sets (each set includes about 500 steps) which is equal to 10000 steps.

In the preliminary work, based on the images D1 included in the training data, the abnormality determination apparatus 1 performs machine learning of the AE 10 (S11). For example, the images D1 of the training data created in S10 are input to the AE 10. Parameters of the AE 10 are updated such that an error between the input and the output of the AE 10 decreases (such that the output of the AE 10 becomes the same as the corresponding input image D1).

For example, the number of training passes is set to 300 epochs, and the AE 10 is trained by using images having a resolution of 300×300 pix which are obtained by reducing the resolution of the 10000 images D1 included in the training data for the 10000 steps.

The abnormality determination apparatus 1 sets a value (latent variable) of the intermediate layer of the AE 10 that has performed learning in S11, as the feature quantity (f1) to be input to the LSTM 11.

In the preliminary work, the abnormality determination apparatus 1 performs learning of the LSTM 11 based on the feature quantity (f1) of the images D1, the sensor data (f2) obtained by the acceleration sensor 101, and the pose information (m1, m2, . . . ) of the robot arm 100 which are included in the training data (S12).

For example, learning of the LSTM 11 is performed such that the LSTM 11 is able to predict a value of the training data for a step at a time (t+1) by using the training data for a step at a time (t). At this time, the image D1 of the training data is input to the AE 10, and the feature quantity (f1) extracted from the image D1 by the AE 10 is used as the input to the LSTM 11. The sensor data (f2) obtained by the acceleration sensor 101 and the pose information (m1, m2, . . . ) which are included in the corresponding training data are directly input to the LSTM 11. The training data (the feature quantities (f1, f2, . . . ) and the pose information (m1, m2, . . . )) for the next step is regarded as a correct answer.

In the preliminary work, the abnormality determination apparatus 1 sets a threshold for the degree of abnormality used for determination and registers the threshold as the setting information 20 (S13). For example, in S13, the robot arm 100 is caused to move properly once. During this period, the degree of abnormality of each step is calculated. In this case, for each of the output nodes (for f1, f2, . . . , m1, m2, . . . ) of the LSTM 11, a value that is 1.2 times as large as the value of the step with the highest degree of abnormality is set as the threshold for the node.

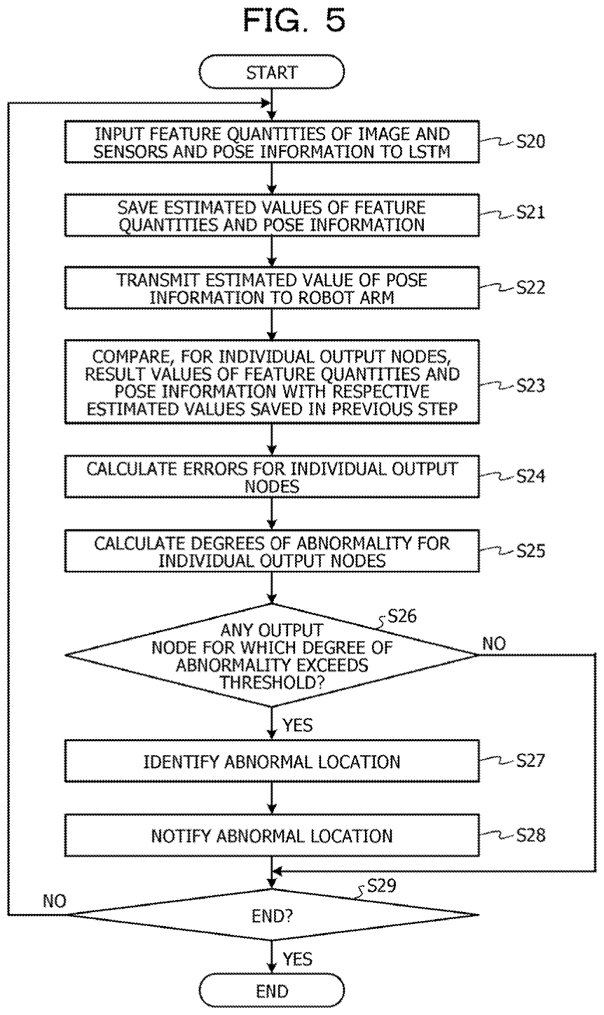

FIG. 5 is a flowchart illustrating an example of an operation of the abnormality determination apparatus 1 according to the first embodiment. As illustrated in FIG. 5, in response to the start of the process, the abnormality determination apparatus 1 inputs the feature quantities (f1, f2, . . . ) from the image and the sensors and the pose information (m1, m2, . . . ) of the robot arm 100 to the LSTM 11 (S20).

The LSTM 11 outputs estimated values of the feature quantities (f1, f2, . . . ) and the pose information (m1, m2, . . . ) for the next step and saves the estimated values in the storage unit 12 (S21).

The abnormality determination apparatus 1 transmits, as a target value, the estimated value of the pose information (m1, m2, . . . ) obtained by the LSTM 11 to the robot arm 100 (S22).

The error calculation unit 13 compares, for the individual output nodes of the LSTM 11, the result values of the feature quantities and the pose information with the respective estimated values saved in the storage unit 12 in the previous step (S23). Based on the comparisons for the individual output nodes, the error calculation unit 13 calculates errors for the individual output nodes (S24).

Based on the error calculated for each of the output nodes by the error calculation unit 13, the degree-of-abnormality calculation unit 14 calculates a degree of abnormality for the corresponding output node by totalizing (or averaging) the values of the error over a plurality of steps (S25).

Based on the degrees of abnormality calculated for the respective output nodes by the degree-of-abnormality calculation unit 14, the abnormality determination unit 15 determines whether there is a node for which the degree of abnormality exceeds the threshold set in the setting information 20 (S26). If there is no node for which the degree of abnormality exceeds the threshold (S26: No), the abnormality determination unit 15 causes the process to proceed to S29.

If there is a node for which the degree of abnormality exceeds the threshold (S26: Yes), the abnormality determination unit 15 refers to the correspondence relationship, included in the setting information 20, between the output nodes of the LSTM 11 and the feature quantities (for the image, the acceleration sensor, . . . ) and the pose information (for the axes J1, J2, . . . ), and identifies an abnormal location corresponding to the output node for which it is determined that there is an abnormality (S27). The output unit 16 notifies a user of the abnormal location identified by the abnormality determination unit 15, for example, by displaying an indication of the presence of an abnormality on a display or the like (S28).

The abnormality determination apparatus 1 determines whether an end condition is satisfied such as whether the motion of the robot arm 100 has reached an end position (S29).

If the end condition is not satisfied (S29: No), the abnormality determination apparatus 1 causes the process to return to the S20, and the process related to control of the motion of the robot arm 100 is continued. If the end condition is satisfied (S29: Yes), the abnormality determination apparatus 1 ends the process related to control of the motion of the robot arm 100.

### Second Embodiment

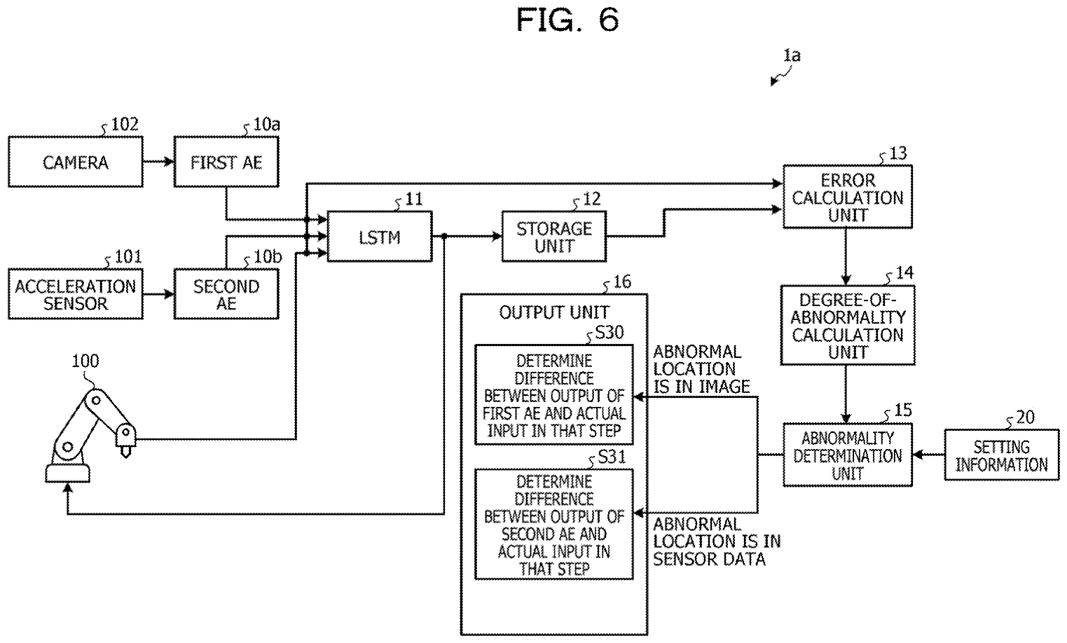

FIG. 6 is a block diagram illustrating an example of a functional configuration of an abnormality determination apparatus according to a second embodiment. As illustrated in FIG. 6, the second embodiment is different from the first embodiment in that an abnormality determination apparatus 1a includes a first AE 10a that extracts a feature quantity from an image D1 obtained by the camera 102 and a second AE 10b that extracts a feature quantity from sensor data (graph image) obtained by the acceleration sensor 101. If it is determined that an abnormal location is in the image obtained by the camera 102 or in the sensor data obtained by the acceleration sensor 101, the output unit 16 outputs image data regarding the abnormal location in accordance with a difference between an input and an output of the first AE 10a (S30) or the second AE 10b (S31).

For example, in the case where the abnormality determination unit 15 determines that the abnormal location is in the image D1 from the camera 102, the output unit 16 obtains a difference between an output of the first AE 10a and an actual input in that step (both the output and the actual input are images) and generates a difference image (S30).

Likewise, in the case where the abnormality determination unit 15 determines that the abnormal location is in the sensor data from the acceleration sensor 101, the output unit 16 obtains a difference between an output of the second AE 10b and an actual input in that step (both the output and the actual input are images) and generates a difference image (S31).

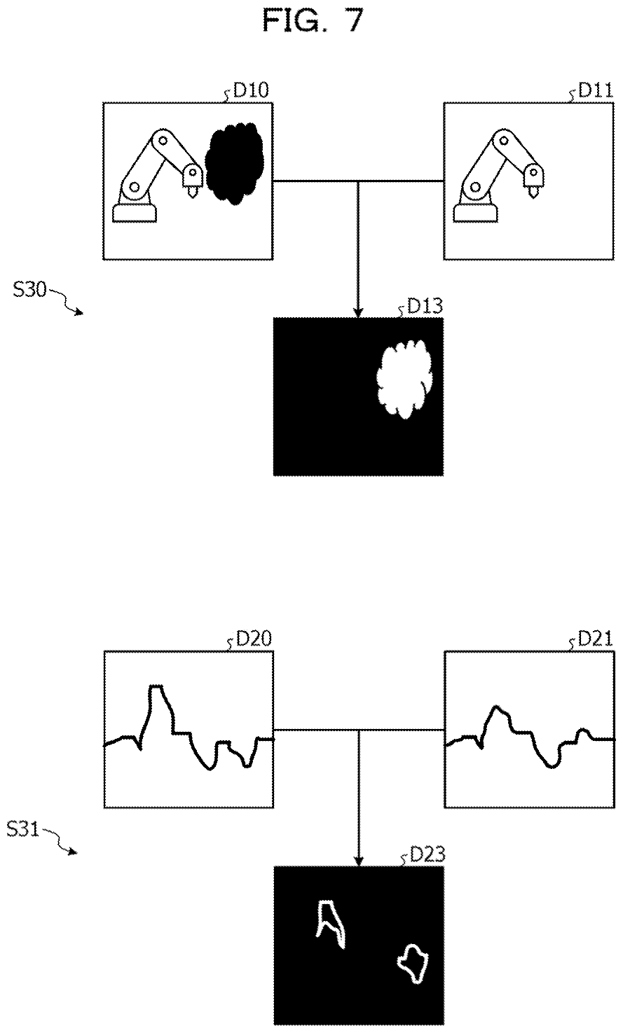

FIG. 7 is an explanatory diagram for describing visualization of the abnormal location. As illustrated in FIG. 7, the output unit 16 generates a difference image D13 based on a difference between an output image D11 of the first AE 10a and an input image D10 of the first AE 10a. Since learning has been performed so that the first AE 10a outputs an image for a normal time, the difference image D13 between the input image D10 and the output image D11 at the time of detection of an abnormality is an image in which the abnormal location is visualized.

Likewise, the output unit 16 generates a difference image D23 based on a difference between an output image D21 of the second AE 10b and an input image D20 of the second AE 10b. Since learning has been performed so that the second AE 10b outputs a graph image of the sensor data for a normal time, the difference image D23 between the input image D20 and the output image D21 at the time of detection of an abnormality is an image in which the abnormal location is visualized.

The output unit 16 displays the generated difference image D13 or D23 on the display. This allows the user to easily identify the abnormal location (for example, a region of the abnormal location in the image obtained by the camera or an abnormal portion in the graph).

As described above, the abnormality determination apparatus 1 generates, based on first motion information of the robot arm 100 for a first timing generated by the machine learning model M1 and a plurality of first feature quantities obtained by sensing the robot arm 100 at the first timing, estimated values of second motion information and a plurality of second feature quantities for a second timing by using the machine learning model M1. The abnormality determination apparatus 1 controls, based on the second motion information, a motion of the robot arm 100 at the second timing, and compares a plurality of second feature quantities obtained by sensing the robot arm 100 at the second timing with the generated estimated values of the plurality of second feature quantities. The abnormality determination apparatus 1 determines whether there is an abnormality based on a result of the comparison processing. In this manner, the abnormality determination apparatus 1 may identify whether there is an abnormality in sensing of the robot arm 100.

The abnormality determination apparatus 1 determines whether there is an abnormality based on a totalized value obtained by totalizing the result of the comparison processing for a plurality of timings. In this manner, the abnormality determination apparatus 1 may determine an abnormality robustly against noise such as a sudden disturbance.

The abnormality determination apparatus 1 compares each of the plurality of second feature quantities obtained by sensing with a corresponding one of the generated estimated values of the plurality of second feature quantities, and determines, based on the individual results, whether there is an abnormality in sensing for acquiring a certain feature quantity. In this manner, the abnormality determination apparatus 1 may easily identify a location where an abnormality has occurred in sensing.

The individual components of each of the illustrated apparatuses do not necessarily have to be physically configured as illustrated. For example, specific forms of the distribution and integration of the individual apparatuses are not limited to the illustrated forms, and all or part thereof may be configured in arbitrary units in a functionally or physically distributed or integrated manner depending on various loads, usage states, and the like.

All or arbitrary part of the various processing functions of the AE 10, the LSTM 11, the error calculation unit 13, the degree-of-abnormality calculation unit 14, the abnormality determination unit 15, and the output unit 16 performed in the abnormality determination apparatus 1 may be executed by a central processing unit (CPU) (or a microcomputer such as a microprocessor unit (MPU) or a micro controller unit (MCU)) which is an example of a control unit. Obviously, all or arbitrary part of the various processing functions may be executed based on a program analyzed and executed by the CPU (or the microcomputer such as the MPU or the MCU) or may be executed by hardware using wired logic. The various processing functions performed in the abnormality determination apparatus 1 may be executed by a plurality of computers in cooperation with each other by cloud computing.

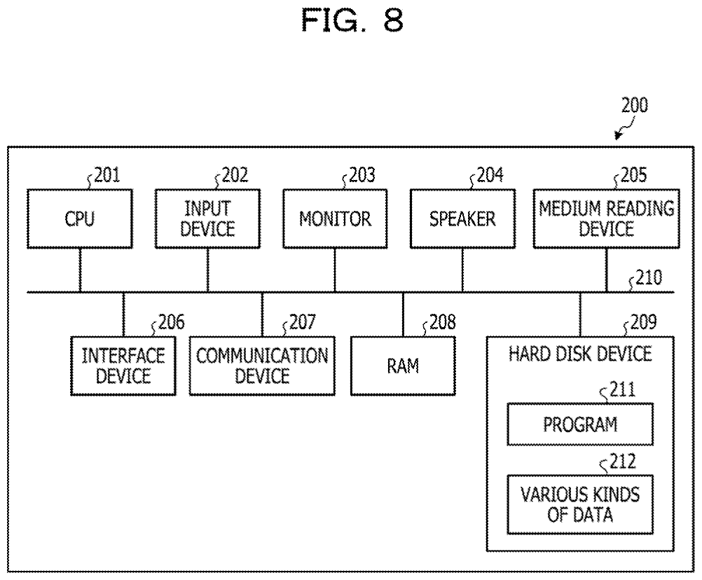

The various processes described in the embodiments above may be implemented as a result of a computer executing a program prepared in advance. Accordingly, an example of a (hardware) configuration of the computer that executes the program having functions similar to those of the embodiments described above will be described below. FIG. 8 is an explanatory diagram for describing an example of the configuration of the computer.

As Illustrated in FIG. 8, a computer 200 includes a CPU 201 that executes various kinds of arithmetic processing, an input device 202 that accepts a data input, a monitor 203, and a speaker 204. The computer 200 also includes a medium reading device 205 that reads a program or the like from a storage medium, an interface device 206 that couples the computer 200 to various devices, and a communication device 207 that communicates with an external apparatus via a wired or wireless link. The computer 200 also includes a random-access memory (RAM) 208 that temporarily stores various kinds of information and a hard disk device 209. Each of the components (201 to 209) of the computer 200 is coupled to a bus 210.

The hard disk device 209 stores a program 211 for executing various processes of the functional configuration (for example, the AE 10, the LSTM 11, the error calculation unit 13, the degree-of-abnormality calculation unit 14, the abnormality determination unit 15, and the output unit 16) described in the embodiments above. The hard disk device 209 also stores various kinds of data 212 to be referred to by the program 211. The input device 202 accepts, for example, an input of operation information from an operator. The monitor 203 displays, for example, various screens in which an operation is performed by the operator. For example, a printer or the like is coupled to the interface device 206. The communication device 207 is coupled to a communication network such as a local area network (LAN) and exchanges various kinds of information with an external device via the communication network.

The CPU 201 reads the program 211 stored in the hard disk device 209, loads the program 211 into the RAM 208, and executes the program 211, thereby performing various processes related to the above-described functional configuration (for example, the AE 10, the LSTM 11, the error calculation unit 13, the degree-of-abnormality calculation unit 14, the abnormality determination unit 15, and the output unit 16). The program 211 does not have to be stored in the hard disk device 209. For example, the program 211 stored in a storage medium readable by the computer 200 may be read and executed. For example, the storage medium readable by the computer 200 corresponds to a portable recording medium such as a compact disc read-only memory (CD-ROM), a digital versatile disc (DVD), or a Universal Serial Bus (USB) memory; a semiconductor memory such as a flash memory; a hard disk drive; or the like. The program 211 may be stored in a device coupled to a public line, the Internet, a LAN, or the like, and the computer 200 may read the program 211 from the device and execute the program 211.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an abnormality determination program for causing a computer to execute a process for determining an abnormality, the process comprising:
generating, based on first motion information of a device generated for a first timing by a machine learning model and a plurality of first feature quantities obtained by sensing the device at the first timing, estimated values of second motion information and a plurality of second feature quantities for a second timing that is after the first timing by using the machine learning model;
controlling, based on the second motion information, a motion of the device at the second timing;
comparing a plurality of second feature quantities obtained by sensing the device at the second timing with the generated estimated values of the plurality of second feature quantities; and
determining, based on a result of the comparing, whether there is an abnormality.

2. The non-transitory computer-readable recording medium according to claim 1, wherein in the determining, it is determined whether there is an abnormality, based on a total of the result and a result of comparing a plurality of feature quantities obtained at an other timing with estimated values of the plurality of feature quantities for the other timing.

3. The non-transitory computer-readable recording medium according to claim 1,
wherein in the comparing, each of the plurality of second feature quantities obtained by sensing is compared with a corresponding one of the generated estimated values of the plurality of second feature quantities, and
wherein in the determining, it is determined, based on the individual results, whether there is an abnormality in sensing for obtaining a certain feature quantity.

4. An abnormality determination method comprising:
generating, based on first motion information of a device generated for a first timing by a machine learning model and a plurality of first feature quantities obtained by sensing the device at the first timing, estimated values of second motion information and a plurality of second feature quantities for a second timing that is after the first timing by using the machine learning model;
controlling, based on the second motion information, a motion of the device at the second timing;
comparing a plurality of second feature quantities obtained by sensing the device at the second timing with the generated estimated values of the plurality of second feature quantities; and
determining, based on a result of the comparing, whether there is an abnormality.

5. The abnormality determination method according to claim 4, wherein in the determining, it is determined whether there is an abnormality, based on a total of the result and a result of comparing a plurality of feature quantities obtained at an other timing with estimated values of the plurality of feature quantities for the other timing.

6. The abnormality determination method according to claim 6,
wherein in the comparing, each of the plurality of second feature quantities obtained by sensing is compared with a corresponding one of the generated estimated values of the plurality of second feature quantities, and
wherein in the determining, it is determined, based on the individual results, whether there is an abnormality in sensing for obtaining a certain feature quantity.

7. An information processing apparatus comprising:
a memory; and
a processor coupled to the memory and configured to:
generate, based on first motion information of a device generated for a first timing by a machine learning model and a plurality of first feature quantities obtained by sensing the device at the first timing, estimated values of second motion information and a plurality of second feature quantities for a second timing that is after the first timing by using the machine learning model;
control, based on the second motion information, a motion of the device at the second timing;
compare a plurality of second feature quantities obtained by sensing the device at the second timing with the generated estimated values of the plurality of second feature quantities; and
determine, based on a result of the comparing, whether there is an abnormality.

8. The information processing apparatus according to claim 7,
wherein it is determined whether there is an abnormality, based on a total of the result and a result of comparing a plurality of feature quantities obtained at an other timing with estimated values of the plurality of feature quantities for the other timing.

9. The information processing apparatus according to claim 6,
wherein each of the plurality of second feature quantities obtained by sensing is compared with a corresponding one of the generated estimated values of the plurality of second feature quantities, and
wherein it is determined, based on the individual results, whether there is an abnormality in sensing for obtaining a certain feature quantity.
